(19) United States
(12) Patent Application Publication
(10) Pub. No.: US 2007/0055597 A1
(43) Pub. Date: Mar. 8, 2007

(54) Method and system for manipulating purchase information

(75) Inventors: Karteek Patel, San Francisco, CA (US); Peter Ciurea, Martinez, CA (US); Sarah Suarez, South San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., San Francisco, CA (US)

(21) Appl. No.: 11/378,215

(22) Filed: Mar. 16, 2006

Related U.S. Application Data
(60) Provisional application No. 60/715,455, filed on Sep. 8, 2005.

(51) Int. Cl. G06Q 40/00; G07G 1/00

(52) U.S. Cl. 705/35; 705/10

(57) ABSTRACT

A method and system for generating customized categories for financial transaction reports associated with portable consumer devices is disclosed. In one embodiment, a financial transaction reporting system is configured to track and output a user's financial transactions associated with the user's portable consumer device for both credit and debit transactions. The system and method automatically assigns financial transactions associated with their credit and/or debit cards with a transaction category such as business, travel, meals and entertainment, etc. based on predefined and/or user-defined merchant categorization codes. The user on a server is provided with the capability to customize the merchant categorization codes and the content of reports derived from the user's financial transactions. The user may customize the report content to specific transaction categories, sub-categories, and time periods.

This application claims priority to U.S. Provisional Patent Application No. 60/715,455, entitled “Method And System For Manipulating Purchase Information” filed Sep. 8, 2005, which is hereby incorporated in its entirety.

### BACKGROUND OF THE INVENTION

The present invention relates in general to financial transactions and in particular to various embodiments of tracking, categorizing, and displaying financial transactions associated with portable consumer devices.

Due to the ease of use and acceptance of electronic transactions by merchants, the use of credit and debit cards for purchasing goods and services is rapidly replacing checks and cash as the preferred method of making purchase transactions. In addition to purchasing clothing, electronics, and other higher-priced products, consumers are increasingly using credit and debit cards to purchase everyday goods and services such as groceries, coffee, sandwiches, utility bills, subscriptions to magazines, etc. However, with such ease of use many consumers lose track of their expenditures.

Currently, tracking credit card and debit card transactions on an ongoing basis, requires a consumer to either log onto a web-based portal of the financial institution who issued the credit or debit card, or wait for a statement to arrive, either via postal mail or perhaps via e-mail. Unfortunately, such information whether obtained through the web-based portal displays a limited amount of information about the transaction such as the transaction date, name of the merchant and the transaction amount. Accordingly, without remembering the details about the transaction and/or name of the merchant, consumers are often left in the dark as to what type of purchase they made. For many companies, the problem is even more exaggerated as employees from different parts of the company often use the same company approved expense report for reimbursement. The company's accounting department often employs a considerable effort to keep track of the employee expenditures, often relying on the employee to enter a categorization code for the transaction. Unfortunately, many employees incorrectly categorize their financial transactions making it difficult for the company to accurately track expenditures.

In order to giver their customers and companies more information about their purchase transactions, some financial institutions offer consumers who use their credit cards, summary financial reports where the financial transactions are categorized for the consumer by purchase categories such as travel, meals and entertainment, supplies, etc. Such reports are generally sent annually which is often of little use to the consumer in tracking financial transactions on an on-going basis. While, such summary reports may provide some useful categorical information for each purchase, such categorical information can be incorrect, and being in printed form, is unchangeable by the consumer. For example, if a restaurant transaction is indicated incorrectly in the summary report as a hardware purchase, the consumer has little if any recourse except to complain to the financial institution who issued the summary report. Therefore, as information currently provided to consumers provides limited information, generally reflects purchases made over a long period of time, and is often incorrect, keeping track of their expenditures for many consumers and companies is often neglected.

Therefore, what is needed is a system and method that allows a user to categorize credit card and debit card transactions in a web-based environment that is simple to use and is cost effective.

### BRIEF SUMMARY OF THE INVENTION

One embodiment of the invention is directed to a method that includes retrieving and then viewing credit and debit card purchases through a client/server enabled user interface. A user logs onto the user interface via network such as the Internet. A transaction server retrieves the transactions from a variety of sources such as financial institutions that record the financial transactions. The financial institutions may be credit or debit card issuers. The method provides initial categories for each transaction with respect to the merchant type and then allows the user to reassign the categories as desired. Once categorized, the user interface allows the user to initiate the generation of custom reports that may be delivered via a web portal page or via e-mail.

Another embodiment of the invention is directed to a method which includes receiving a user registration for one or more portable consumer devices such as a credit or debit card via a network supported user interface. The method further includes receiving purchase information for the one or more portable consumer devices and generating a report which includes purchase information including purchase categories that are customizable by a user. A user is capable of registering one or more portable consumer devices and can initiate the generation of reports only with respect to those registered portable consumer devices.

Another embodiment of the invention is directed to a financial tracking and reporting system. The system includes a financial data input system capable of receiving financial transactions from portable consumer devices, a data categorization system capable of categorizing at least some of the financial transactions into one of a plurality of transaction categories based on a merchant classification code, and a transaction reporting system capable of generating financial reports using categorized financial transactions. In embodiments of the present invention, the data categorization system is capable of customizing the transaction categories in response to a user input.

Other embodiments of the invention are described in detail below.

### BRIEF DESCRIPTION OF THE DRAWINGS

FIG. 1 is a high-level functional diagram of a financial transaction tracking system in accordance with embodiments of the invention;

FIG. 2 is a simplified block diagram of a financial transaction tracking and reporting system embodiment of the financial transaction tracking system of FIG. 1 in accordance with embodiments of the invention;

FIG. 3 is flow diagram illustrating a method of categorizing financial transactions in accordance with embodiments of the invention;

FIG. 4 is flow diagram illustrating a method of reporting financial transactions in accordance with embodiments of the invention;

FIG. 5 is a simplified graphical display illustrating a portable consumer device registration interface in accordance with embodiments of the invention;

FIG. 6 is simplified graphical display of a home page interface in accordance with embodiments of the invention;

FIG. 7 is simplified graphical display of a user's inbox interface in accordance with embodiments of the invention;

FIG. 8 is a simplified graphical display illustrating a data export interface in accordance with embodiments of the invention;

FIG. 9 is a simplified graphical display illustrating a transaction category modification interface with an expanded category tree in accordance with embodiments of the invention;

FIGS. 10A-E are simplified graphical displays illustrating transaction category modification windows associated with the transaction category modification interface of FIG. 9, in accordance with embodiments of the invention;

FIG. 11 is a simplified graphical display illustrating an e-mail list management interface in accordance with embodiments of the invention;

FIG. 12 is a simplified graphical display illustrating a non-scheduled report interface in accordance with embodiments of the invention;

FIG. 13 is a simplified graphical display illustrating a scheduled report interface in accordance with embodiments of the invention;

FIG. 14 is a simplified graphical display illustrating a monthly financial transaction summary report for a user in accordance with embodiments of the invention;

FIG. 15 is a simplified graphical display illustrating a monthly financial transaction detail report for a user in accordance with embodiments of the invention;

FIG. 16 is a simplified graphical display illustrating a financial transaction spending detail report for a user in accordance with embodiments of the invention;

FIG. 17 is a simplified graphical display illustrating a monthly financial transaction spending report for an individual user categorized by merchant type including merchant detail in accordance with embodiments of the invention; and

FIG. 18 is a simplified graphical display illustrating a company monthly financial transaction summary report categorized by merchant type in accordance with embodiments of the invention.

### DETAILED DESCRIPTION

Embodiments of the invention include a web-based financial transaction tracking and reporting tool created for debit and credit cardholders. Embodiments of the invention provide a system and method that automatically assigns financial transactions associated with their credit and/or debit cards with a transaction category such as business, travel, meals and entertainment, etc. based on predefined and/or user-defined merchant categorization codes (merchant CCs). Embodiments of the invention further provide a system and method to allow cardholders to view, categorize, and automatically receive e-mail reports of their financial transactions. The reports are customizable and allow users to choose from a plurality of flexible spending reports designed to meet their unique needs, giving cardholder's greater control over tracking their expenses. In one embodiment, cardholders who have credit and debit cards from the same participating issuer can receive consolidated reports for both types of cards.

Embodiments of the invention provide cardholders with a plurality of spending reports containing comprehensive expense information on a monthly, quarterly, and/or annual basis. The reports offer detailed spending analyses for a plurality of merchant CCs including, for example, business services, materials and supplies, general merchandise, travel, lodging, meals and entertainment, vehicle, cash advances, etc.

Credit and debit cards are described in detail. However, embodiments of the invention can use other types of portable consumer devices. Accordingly, the portable consumer devices according to embodiments of the invention may be in any suitable form. For example, the portable consumer devices can be hand-held and compact so that they can fit into a consumer's wallet and/or pocket (e.g., pocket-sized). For example, the portable consumer devices may include smart cards, ordinary credit or debit cards (with a magnetic strip and without a microprocessor), a keychain device (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

A “merchant” in embodiments of the invention can have any suitable characteristics. A merchant may include entities such as corporations, sole proprietorships, non-profit organizations, or a specific group of such entities. Examples of merchants include restaurants, theaters, gasoline and fuel stores, grocery stores, clothing retailers, department stores, etc. The merchant has one or more point-of-sale (POS) terminals that can interact with the portable consumer devices.

An “acquirer” is typically a business entity, e.g., a commercial bank that has a business relationship with a particular merchant. An “issuer” is typically a business entity (e.g., a bank) that issues a portable consumer device such as a credit or debit card to a consumer. Some entities such as American Express perform both issuer and acquirer functions. Embodiments of the invention encompass such single entity issuer-acquirers.

An “authorization request message” can include a request for authorization to conduct an electronic payment transaction or some other type of activity. It may include one or more of an account holder's payment account number, currency code, sale amount, merchant transaction stamp, acceptor city, acceptor state/country, POS transaction number, POS transaction type (e.g., POS 90), etc. Optionally, an authorization request message may be protected using a secure encryption method, e.g., 128-bit SSL (secure socket layer) or equivalent-in order to prevent data from being compromised. In other embodiments, an “authorization request message” may include a request for permission to enter a predetermined location (e.g., as used for wireless access badges).

When a consumer uses their credit or debit card to make a clothing purchase at a merchant, a financial transaction authorization process is invoked. The merchant transmits the authorization request along with the user's account number, merchant account number (i.e., merchant identification for the payment processing system), account expiration date, etc. to a payment processing system. If the transaction is approved, a record of the transaction may be stored in database along with the merchant identification, date of purchase, amount, etc. The financial transactions may be stored in any number of database format types such as DBASEII, Oracle, SQL, and the like.

The payment processing system generally provides data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a single message system (SMS) that automatically authorizes and provides enough information to automatically clear and settle a financial transaction, and a VIP system (Visa Integrated Payments system) which processes authorization requests and a Base II system which performs clearing and settlement services.

Typically, an electronic payment transaction is authorized if the consumer conducting the transaction has sufficient funds or credit to conduct the transaction. Conversely, if there are insufficient funds or credit in the consumer's account, or if the consumer's portable consumer device is on a blacklist (e.g., it is indicated as stolen), then an electronic payment transaction may not be authorized.

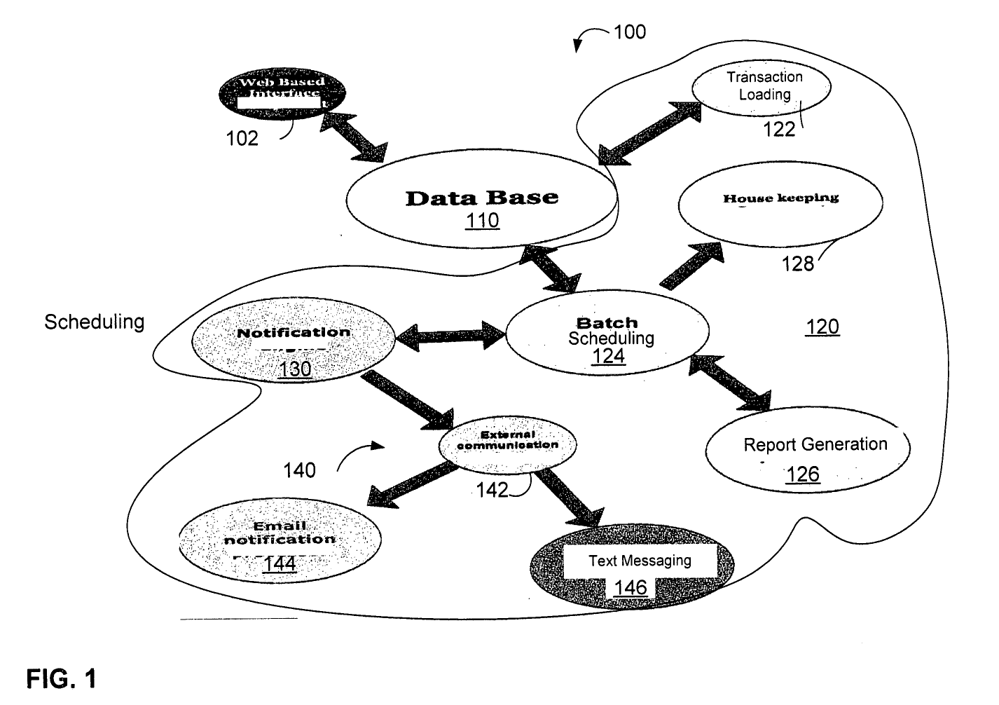

FIG. 1 is a high-level functional diagram of a financial transaction tracking module 100. The financial transaction tracking module 100 provides a process where a user may view, categorize, and generate reports about financial transactions associated with portable consumer devices such as credit and debit cards. In one embodiment, the financial transaction tracking module 100 includes a user interface module 102, a database 110, and a financial transaction tracking and reporting module 120. The user interface module 102 allows a user to interact with the transaction tracking module 100 via a network connection such as the Internet. In one embodiment, the user interface module 102, in conjunction with a browser interface establishes a web-based portal allowing a user to, view, categorize, and/or create custom reports, and establish report delivery schedules for financial transactions stored on database 110 as further described below. For example, the user interface module 102 may enable a user to interactively input or select a transaction category for a given purchase transaction, and/or allow the financial transaction tracking module 100 to automatically assign default transaction categories associated with merchant information usually included with the financial transaction information.

In one embodiment, user interface module 102 may be enabled by software capable of establishing a network session with a client application such as browser software. A browser is generally capable of establishing a graphical user interface (GUI) with a server computer over a network connection, such the Internet. The GUI interface enables a user to graphically interact with one or more servers using dialog boxes, buttons, text entry windows, etc. For example, browsers are often installed on a user's computer (e.g., client side) to allow a user to view and interact with software on a network via servers hosting such software (e.g., server side). For example, millions of user's interact with server hosted web-pages on the Internet through their computer's browser software (e.g., Internet Explorer, Mozilla, etc.). Illustratively, many banks and credit card companies offer web-based portals to allow a user to view and interact with their accounts via a network connection, such as the Internet, though a browser resident on the user's computer. Such client-server interactivity allows a user to operate software programs on a server of the network without the need to purchase and install the software on their computer.

Financial transaction tracking and reporting module 120 includes a transaction loading module 122, a housekeeping module 128, a notification module 130, a batch scheduling module 124, and a report generation module 126. The transaction loading module 122 is capable of receiving financial transaction data, merchant data, etc. from a plurality of databases, such as database 110. For example, the transaction loading module 122 may be integrated with, or receive the financial transaction data from any combination of the payment processing system, the merchant, the acquirer, or the issuer. The transaction loading module 122 receives, processes, and transmits the financial transaction data to the database 110 for storage thereof.

The housekeeping module 128 is capable of generating system reports, process error notifications, and the like, associated with financial transaction tracking and reporting module 120. Notification module 130 communicates with a delivery module 140 which includes an external communication module 142. Delivery module 140 provides the financial transaction tracking and reporting module 120 with the capability of delivering financial transaction reports to end users, companies, and the like, as described herein. External communication module 142 is capable of communicating with processes external to the notification module 130 such as an e-mail notification module 144 and a text message module 146 described below.

The batch scheduling module 124 is capable of controlling when financial reports are generated and delivered to end users according to a predetermined schedule. In one embodiment, batch scheduling module 124 communicates with the report generation module 126 to generate financial reports, reminders, and other messages either in a default form, or customized for the needs of a given application. The reports and notifications once generated may be delivered to the user in real-time on demand, or stored for later delivery via the notification module 130. The notification module 130 is in communication with and controlled by the batch scheduling module 124. In one embodiment, notification module 130 is in communication with and controls delivery module 140 and therefore external communication module 142. In one embodiment, external communication module 142 is capable of outputting the reports, notifications, messages, etc. to the user via the e-mail notification module 144 and/or by sending a text message to the user via the text message module 146.

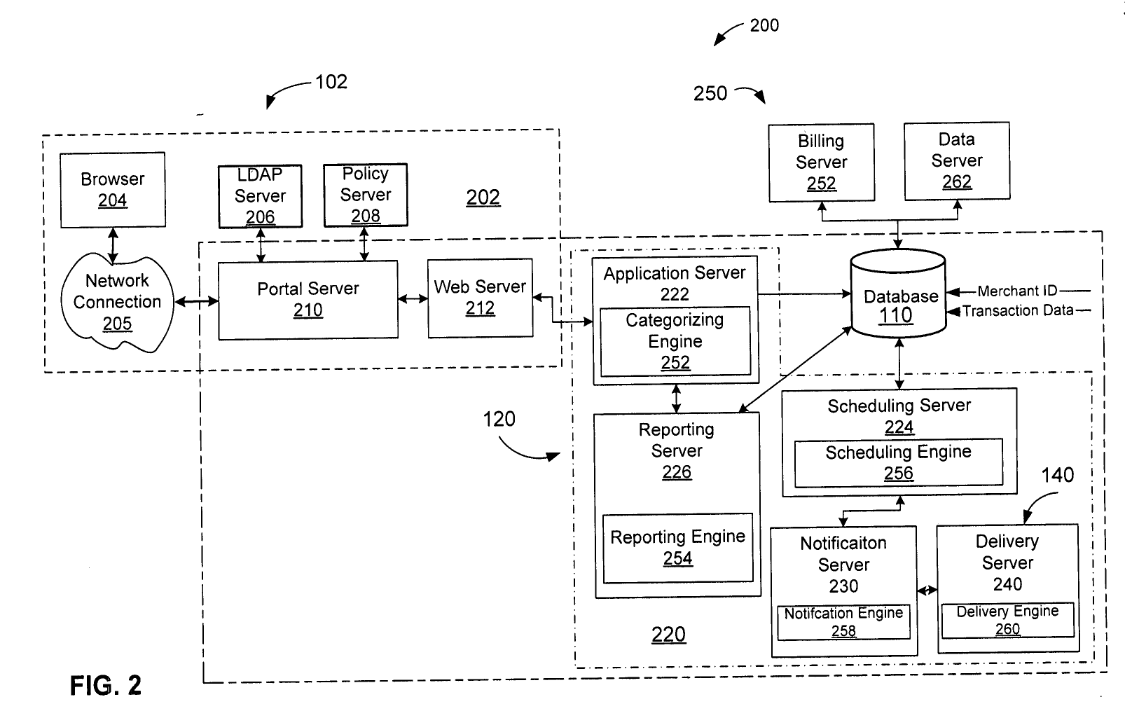

FIG. 2 is a simplified block diagram of a financial transaction tracking and reporting system 200 embodiment of financial transaction tracking module 100. In one embodiment, the user interface module 102 of FIG. 1 is enabled via a user interface system 202. The user interface system 202 includes a portal server 210, a web-server 212, and a browser 204. The portal server 210 is capable of establishing a network connection with browser 204 via a network connection 205, such as the Internet. For example, when a user logs onto the financial transaction tracking and reporting system 200 via browser 204, a network session is started with the portal server 210. The web-server 212 provides graphical and textual content (e.g., web-pages) generated by the financial transaction tracking and reporting system 200 to the browser 204. The user interface system 202 optionally includes a lightweight directory access protocol (LDAP) server 206 and a policy server 208 coupled to the portal server 210. The LDAP server 206 and the policy server 208 are capable of providing, session protocols, and communication rules to allow the data transmitted between the browser 202 and financial transaction tracking and reporting system 200 to be interchanged in accordance to rules supplied for example, by a network administrator. The portal server 210 optionally provides a secure socket connections (e.g., secure-socket-layer) and one or more firewalls to keep unauthorized users from accessing the financial transaction tracking and reporting system 200.

Embodiments of financial transaction tracking and reporting system 200 are capable of retrieving and processing financial data derived from internal and external data sources such as database 110. For example, data associated with financial transactions such as merchant CCs, purchase data, merchant name, amount, etc. may be derived from any number of sources 250 such as a databases associated with billing server 252 and from databases associated with issuer specific servers designed to accommodate commercial business such as a data server 262 used for retail business transactions. The financial transaction tracking and reporting system 200 is also capable of retrieving the financial transactions and associated transaction data, or portions thereof, from the merchant, the acquirer, the issuer, or the payment processing system.

In one embodiment, the financial transaction tracking and reporting system 200 includes an application server 222, a reporting server 226, a scheduling server 224, a notification server 230, and a delivery server 240. The application server 222, reporting server 226, scheduling server 224, notification server 230, and delivery server 240 are capable of providing the batch scheduling module 124, the report generation module 126, the housekeeping module 128, the notification module 130, and the delivery module 140 described above.

When a user logs onto the financial transaction tracking and reporting system 200 via the user interface system 202, a network session is started between the browser 204 and the user interface system 202. Once logged on, the user interacts with web server 212 which is capable of delivering data and graphical content processed by application server 222 to the browser 204. For example, a user may request to view financial transactions stored on the database 110. The web server 212 communicates with the application server 222 which queries the database 110 to retrieve the requested financial transaction data. The web server 212 transmits the information received from the application server 222 through the portal server 210 to browser 204 over the network connection 205.

The application server 222, is capable of operating a categorization engine 252. The categorization engine 252 is capable of assigning financial transactions, such as those stored in database 110, with a merchant category type herein referred to as a transaction category. Transaction categories represent financial transaction categories such as business services, travel, meals and entertainment, supplies, etc. and sub-categories which are more specific financial transaction categories associated with the transaction category. In one embodiment, the categorization engine 252 associates default transaction categories with financial transactions based on merchant CCs. For example, if a merchant has a merchant CC of ten, the categorization engine 252 queries a lookup table stored for example, in database 110, to find the transaction category for a merchant CC of ten. If the merchant CC of ten is associated with the transaction category of “supplies”, the categorization engine 252 assigns the merchant with the transaction category of “supplies”.

In one embodiment, the merchant CC may be derived from a variety of sources and methods. The Merchant CC as described herein refers to a merchant classification code that may be supplied by the merchant, the acquirer, the payment processing system, etc. to classify which type of business product, service, etc. is provided (e.g., travel, auto, building supplies, and the like). For example, the merchant may receive the merchant CC by enrolling with the acquirer who then assigns a merchant CC to the merchant. It is contemplated that the merchant CC may be derived from other sources as well, such as the merchant account number, merchant name, and the like. For example, the categorization engine 252 may use the merchant account number, merchant name, transaction ID, etc. to query a database where the merchant account number, the name of the merchant, and the like, are stored and associated with a merchant CC. In other embodiments, the merchant CC may also be derived using an algorithm that converts the merchant account number, the name of the merchant, and the like to the merchant CC. For example, for an algorithm of “2*merchant account number=Merchant CC”, if the merchant account number equals 1214, then the merchant CC equals 2428. In one embodiment, the merchant CC may be equivalent to information already available such as the merchant account number.

The categorization engine 252 is capable of allowing the user to customize the categorization of the financial transactions. For example, the categorization engine 252 allows a user to change the transaction category, move transaction categories from one transaction category to another transaction category, add a new transaction category, delete a transaction category, restore the original default transaction categories, etc. Any or all of theses can be used to customize a list of transaction categories. In one embodiment, the categorization engine 252 allows a user to search for a transaction category and sub-category for a given merchant. For example, if a user wants to search to see what type of transaction category and sub-category a particular merchant such as “Scott's building supplies” belongs to, the user can search using all or a portion of the merchant name “Scott” to find a listing of transaction categories and sub-categories associated with the phrase “Scott”. In this case, “Scott's building supplies” may turn up in the search, and the results may show this merchant being categorized under a “material supplies” transaction category” and “lumber” sub-category.

In one embodiment, the categorization engine 252 enables the user to modify and/or generate transaction categories and sub-categories (e.g., merchant types) for the needs of a given application. For example, in one case, a business traveler may want to categorize his financial transactions around travel. The business traveler may categorize his financial transactions around preferred transaction categories such as “airfare”, “lodging”, “meals and entertainment”, “transportation”, etc. In another case, a building subcontractor, who rarely travels, may customize his financial transactions around his particular contracting business by categorizing his purchases under transaction category headings such as “supplies”, “building costs”, “permits”, “equipment rental”, etc.

Embodiments of categorization engine 252 provide a company the ability to customize the transaction categories for its individual employees. For example, financial transactions related to product sales can be optimized for sales staff employees, whereas financial transactions related to manufacturing can be optimized for manufacturing employees. This is advantageous as it provides the company with a method to tailor the employee's expenditures to that employee's particular role in the company. This allows the company to track expenditures more reliably and efficiently as the individual employees are only concerned about their particular transaction categories.

In one embodiment, the reporting server 226 operates a reporting engine 254. The reporting engine 254 communicates with both the database 110 and application server 222 as needed to generate financial reports for viewing and/or delivery. Financial reports generated may be viewed via browser 204 and/or stored on the database 110 for delivery. Reporting engine 254 is capable of generating reports about financial transactions associated with one or more users, credit or debit card accounts, periods of time, categories, merchant names, etc. For example, in one embodiment, the reporting engine 254 is capable of generating transaction summaries for a user by transaction category and by merchant name over a time period such as monthly, quarterly, annually, etc. The reporting engine 254 is also capable of generating transaction summaries for a company by transaction category and merchant name on a monthly, quarterly, and annual basis for a plurality of employee transactions.

In one configuration the scheduling server 224 employs a scheduling engine 256 to generate financial reports on a scheduled basis. The scheduling engine 256 is capable of providing the user with default schedules, custom schedules, report output type, etc., based on the needs of a given application. For example, the scheduling engine 256 allows the user to choose a report name, report delivery frequency, add a report, select a report format, add or remove delivery e-mail addresses to change a report distribution list, etc., examples of which are described below.

The scheduling server 224 is coupled to a notification server 230. The notification server 230 employs a notification engine 258 capable of notifying a user via e-mail, text message, and the like, that the user's scheduled report's are ready, or will be ready on a given date. The notification server 230 employs a delivery server 240 to mange the delivery of the reports and/or the notifications to the user. In one embodiment, the deliver server 240 employs a delivery engine 260 capable of delivering the scheduled reports via e-mail and/or the notifications via e-mail and/or text messages to a user's pager, cellular phone, and the like.

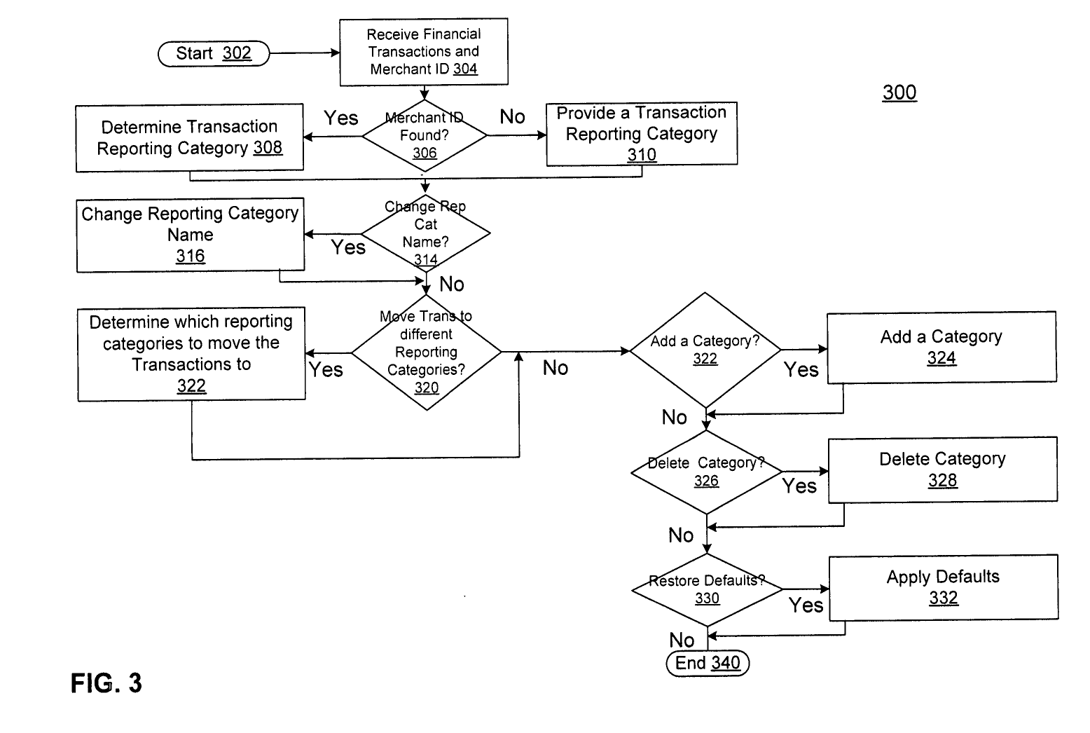

FIG. 3 is flow diagram illustrating a method 300 of tracking and categorizing financial transactions. Method 300 starts at step 302, for example, when a user interacts with financial transaction tracking and reporting system 200. For example, in one embodiment, after a user has logged on with a user name and password, the user may navigate via a user interface to perform a number of operations such as register for an account, view the user's account details, register portable consumer devices, view a summary of financial transactions associated with the user's account, view the data the user has exported, and the like.

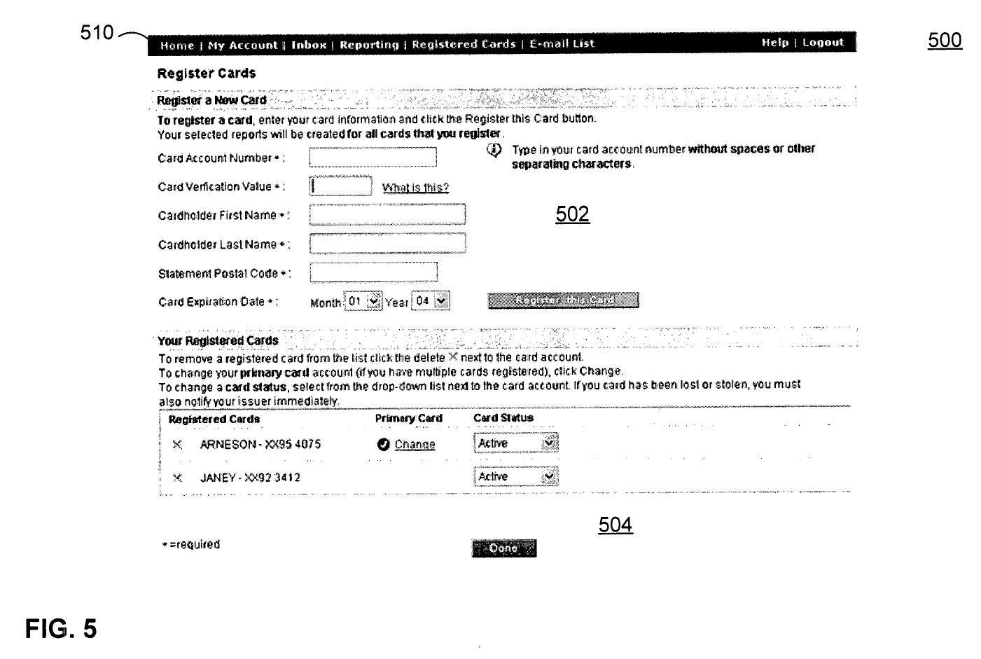

FIG. 5 shows a simplified graphical display illustrating a portable consumer device registration interface 500. In one embodiment, portable consumer device registration interface 500 is configured to register unregistered portable consumer devices and/or view portable consumer devices already registered to the user's account. For example, registration interface 500 may include a registration window 502 and currently registered window 504. Registration window 502 allows a user to enter a card account number, card verification value (e.g., CVV2), a cardholder name, and the like. Currently registered window 504 allows a user to view those portable consumer devices already registered to the account.

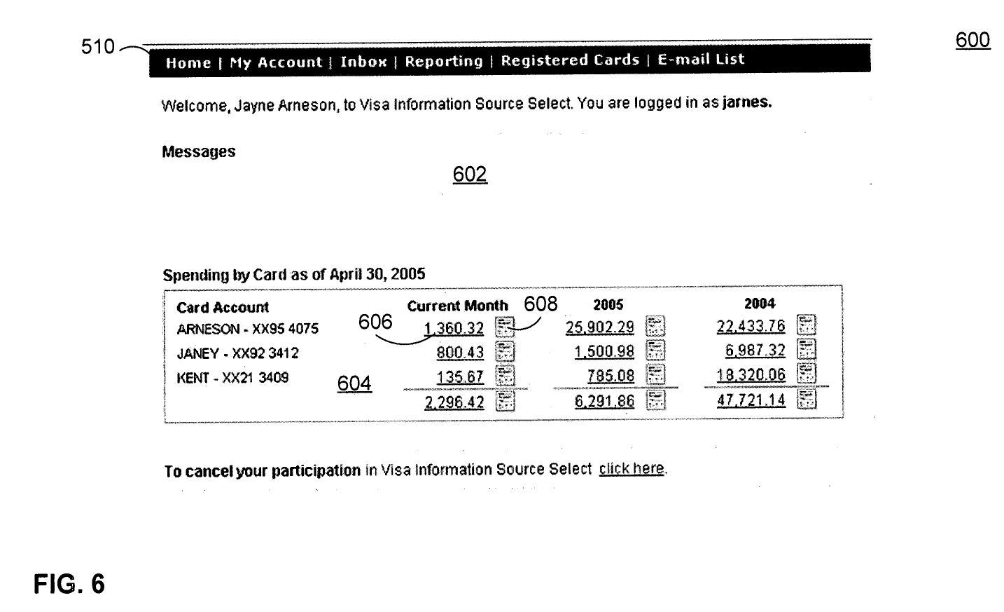

In another embodiment, the user may use a navigation bar 510 to navigate to an account summary page to view their account details. For example, FIG. 6 shows a simplified graphical display of a home page interface 600. In one embodiment, home page interface 600 is configured to show the user any system messages and a summary of spending by the user's registered portable consumer devices. For example, home page interface 600 may include a message window 602 and spending summary window 604. Message window 602 allows a user to see any messages supplied by the financial transaction tracking and reporting system 200, for example, from the housekeeping module 128. For example, message window 602 may provide the user with a message concerning when a financial report will be sent to his e-mail distribution list. Spending summary window 604 allows a user to view the spending balances by registered portable consumer device for a given month, annually, etc. In one embodiment, spending summary window 604 allows a user to generate a summary spending report by selecting the hyperlink 606 for each monetary total, or a detailed spending report by selecting icon 608 disposed adjacent to the respective spending balances.

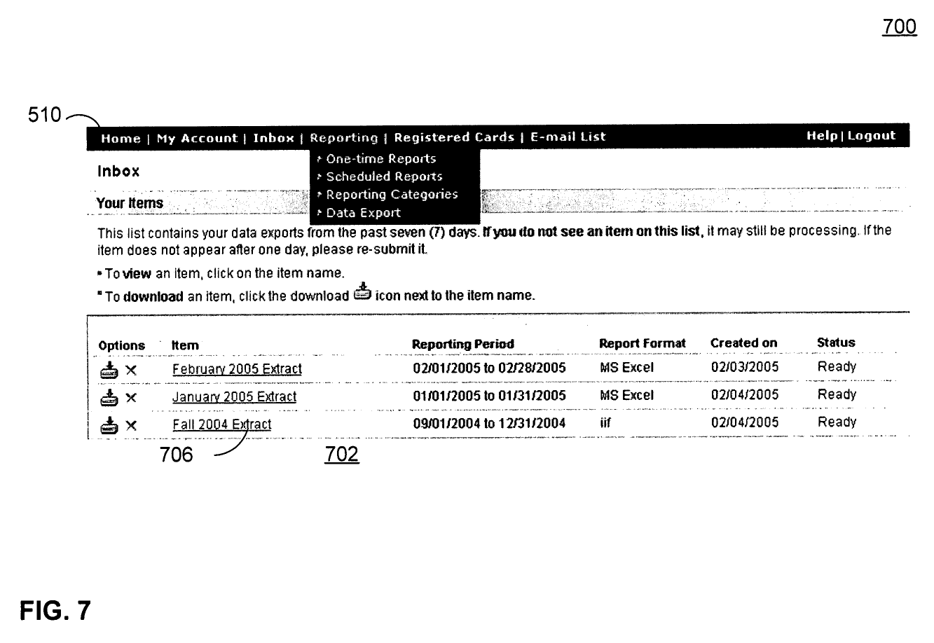

In another embodiment, the user may use navigation bar 510 to navigate to an account inbox page to view the financial data the user previously exported. For example, FIG. 7 shows a simplified graphical display of an inbox page interface 700. In one embodiment, inbox interface page 700 is configured to show the user a summary of the financial data the user exported, the type of file the user exported (e.g., spreadsheet, PDF format, etc.), the date the export was created, status of the export, and the like. For example, inbox interface page 700 may include an export window 702 which allows a user to see data exported over a predetermined time period, view the reporting period, format, date created, and whether the report is ready to be viewed and/or downloaded. In one embodiment, export window 702 allows a user to generate another data extract of the exported data by selecting the respective hyperlink 706 for a given exported report.

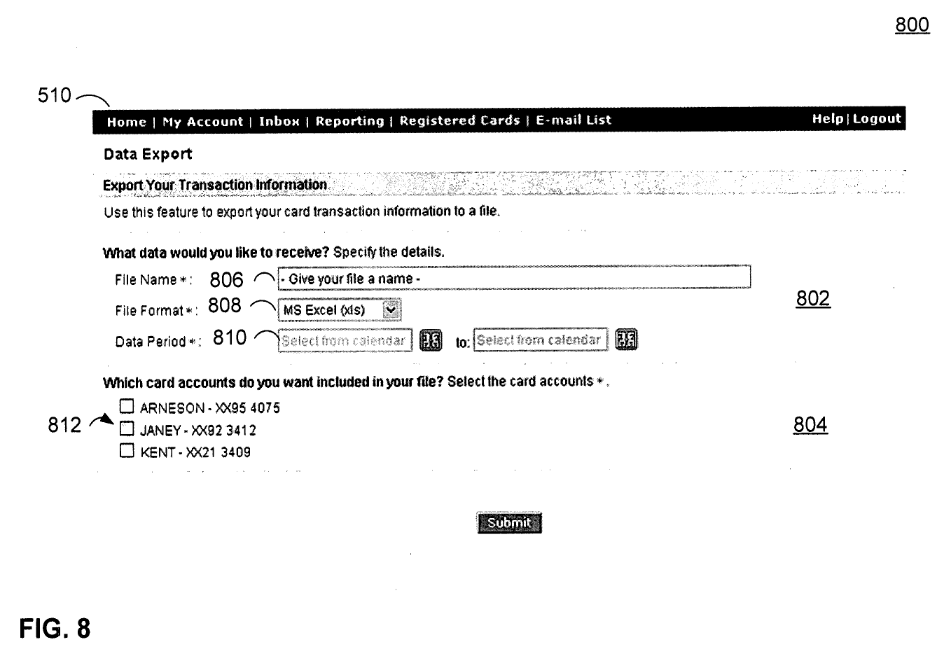

To derive such export data, the user may use navigation bar 510 to navigate to an data export page to view the financial data the user exported, or to generate a new data export. For example, FIG. 8 shows a simplified graphical display of a data export interface 800. In one embodiment, data export interface 800 is capable of providing section boxes, check boxes, etc. to generate an export file. For example, as illustrated, data export interface 800 includes export name window 802 and portable consumer device selection window 804. Export name window 802 may include a file name dropdown box 806, a file format selection dropdown box 808, and time period selection windows 810. The file name dropdown box 806, file format selection dropdown box 808, and time period selection windows 810, enable a user to select or generate an export file for a given output format and time period. Portable consumer device selection window 804 provides checkboxes 812 to allow a user to export data selected from export name window 802 for any of the registered portable consumer devices.

Referring now to FIG. 3, at step 304, the method 300 receives account information and financial data from, for example, database 110. Table 1 illustrates one embodiment of financial transactions and merchant CCs associated with purchase transactions made by the user using the user's credit or debit cards during a two-week business trip, where the transactions include both business transactions and personal transactions. While the transactions may contain a variety of information pertaining to the purchase such as merchant name, purchase authorization, amount, date, time, terminal number, transaction ID, merchant CC, merchant account number, etc. for clarity in this example, only the name of the merchant, the amount of the transaction, the date of the transaction, the transaction number, and the merchant CC are shown.

TABLE 1

| Merchant | | | | Merchant |
|---|---|---|---|---|
| Name | Amount | Date | Transaction ID | CC |
| United Airlines | $272.94 | Dec. 14, 2005 | 51757689430 | 11220 |
| McDonalds | $7.89 | Dec. 14, 2005 | 31778493022 | 24577 |
| Mobil | $34.22 | Dec. 14, 2005 | 45590040404 | 36747 |
| Holiday Inn | $1,087.34 | Dec. 29, 2005 | 57789887989 | 56000 |
| Southwest | $312.87 | Dec. 29, 2005 | 30945758690 | 18383 |
| Airlines | | | | |
| Shell | $32.87 | Dec. 29, 2005 | 39989939399 | 33831 |
| Burger King | $15.12 | Dec. 29, 2005 | 45782920200 | |
| Home Depot | $56.89 | Dec. 30, 2005 | 45738392011 | 60121 |
| Disneyland | $221.45 | Dec. 31, 2005 | 45792020002 | 25789 |
| AAA | $45.00 | Dec. 31, 2005 | 57830930339 | 89899 |

At step 306, if the user decides to view and/or initiate the generation of reports pertaining to the financial transactions, a determination is made if the financial transactions include a merchant CC. In one embodiment, as described above, the merchant CC shown in Table 1, may be derived from a separate database than the database used to store data related to the financial transaction, such as the merchant account number. Therefore, the transaction may not contain a merchant CC. If the database being queried does not include a merchant CC then at step 310 the financial transactions are assigned default categories. For example, as illustrated in Table 1, the transaction for the merchant Burger King did not include a merchant CC. Therefore the merchant Burger King would be assigned a default category such as “not categorized”. The default category may also be assigned using other data related to the merchant such as the merchant name, POS, etc. If the financial transactions include a merchant CC, then at step 308 the financial transactions are assigned a category associated with the merchant CC.

Table 2 illustrates the merchants from table 1 assigned with some example default transaction categories such as “travel”, “meals & entertainment”, “lodging”, “travel”, “vehicle”, “not categorized”, “materials & supplies”, “business services”, and respective sub-categories “united”, “eating places/restaurants”, “service station”, “coast hotels”, “southwest”, “construction materials”, and “auto associations”. The transaction categories and sub-categories in table 2 are predetermined, not yet customized, and may be stored in a database such as database 110.

TABLE 2

| Merchant | Merchant | Transaction | Transaction |
|---|---|---|---|
| Name | CC | Category | Sub-Category |
| United Airlines | 11220 | Travel | United |
| McDonalds | 24577 | Meals & | Eating Places/ |
| | | Entertainment | Restaurants |
| Mobil | 36747 | Vehicle | Service Station |
| Coast Hotels | 56000 | Lodging | Coast Hotels |
| Southwest | 18383 | Travel | Southwest |
| Airlines | | | |
| Shell | 33831 | Vehicle | Service Station |
| Burger King | | Not Categorized | |
| Home Depot | 60121 | Materials & Supplies | Construction |
| | | | Materials |
| Disneyland | 25789 | Meals & | Eating Places/ |
| | | Entertainment | Restaurants |
| AAA | 89899 | Business Services | Auto Associations |

Once the method 300 assigns a transaction category and sub-category to a particular transaction, method 300 proceeds to steps 314-340 to modify the transaction categories and/or sub-categories as desired by a user. Using any or all of the steps (e.g., 306, 314, 320, 322, and/or 326) a user can form a list of categories that is customized to that use. For example, a user may use navigation bar 510 to navigate to a reporting categories page where the user is provided with selections to change the transaction category names, move sub-categories from one transaction category to another transaction category, add a new transaction category, delete a transaction category, restore the original default transaction categories, etc.

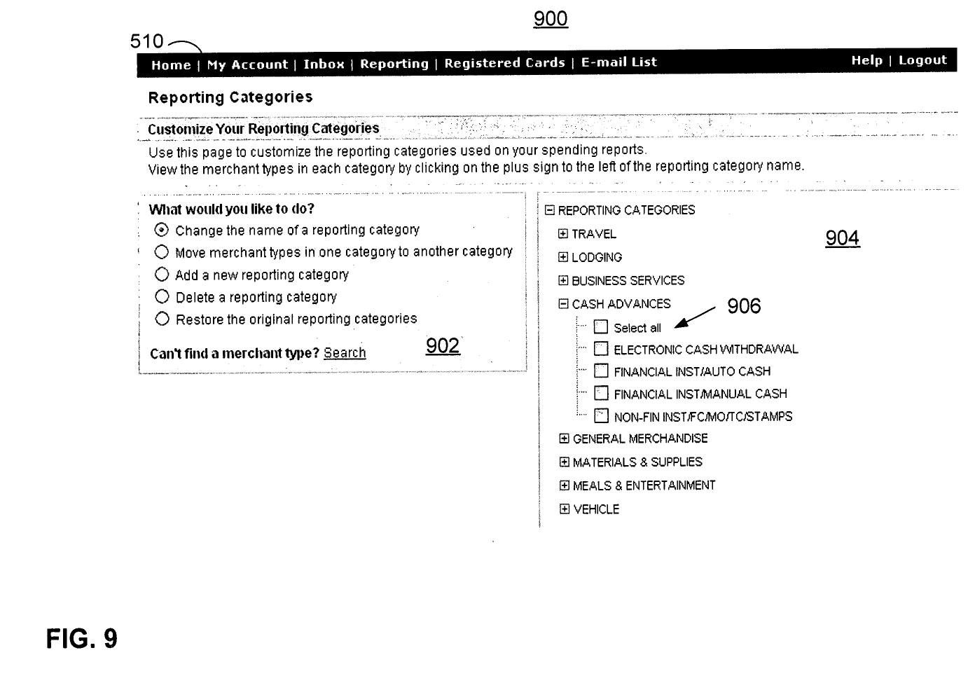

For example, in one embodiment, FIG. 9 shows a simplified graphical display of a financial transaction category modification interface 900 in accordance of one embodiment of the present invention. Financial transaction category modification interface 900 includes a modification selection window 902 and a category tree window 904. Modification selection window 902 is capable of providing a user with check boxes, selection bubbles, and the like to modify the name of the transaction categories, move sub-categories, add new transaction categories, delete a transaction category, restore a default transaction category, and the like.

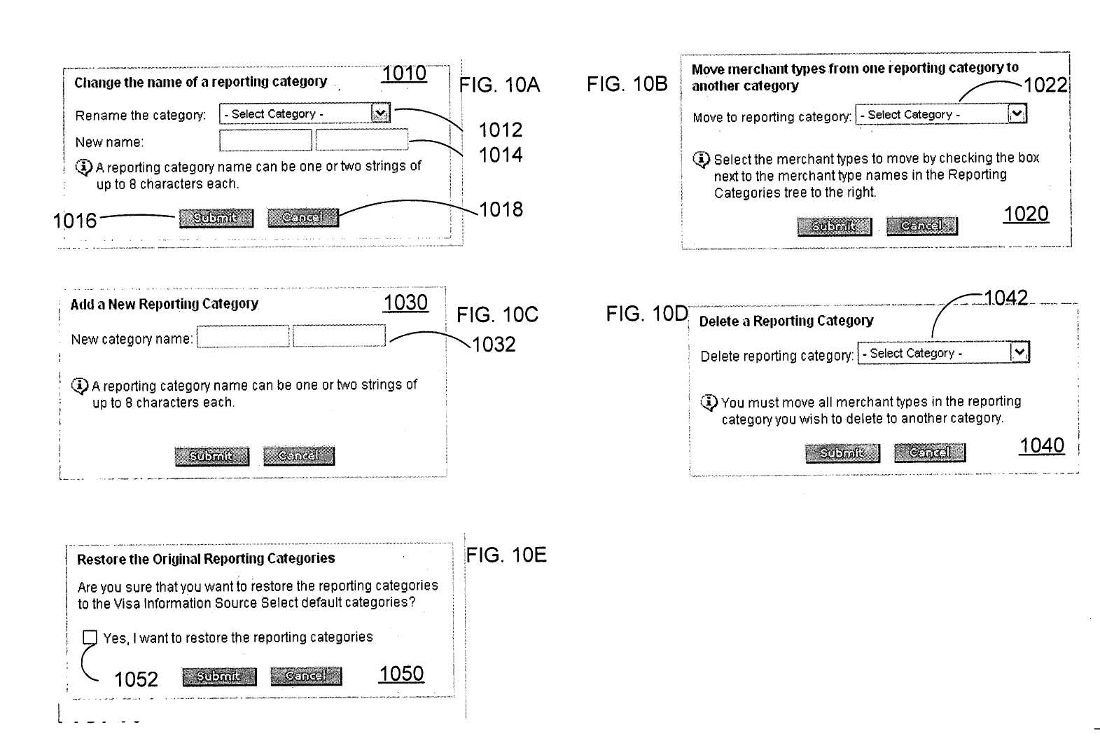

Referring to FIG. 3, FIG. 9, and FIG. 10A, for example, at step 314, a determination is made whether to change the name of a transaction category. For example, in FIG. 10A, a user interface 1010 provides the user with drop down box 1012 or text boxes 1014 to change the name of a transaction category from, for example, “travel” to “business travel”, using the submit button 1016 to finalize the modification process at step 316. If the user does not want to change the transaction category name, then the method 300 proceeds to step 320, for example, when the user selects cancel button 1018.

Table 3 illustrates the effect of the user using use drop down box 1012, for example, to rename the transaction category “materials and supplies” to “new building project” to help categorize transactions with respect to a particular task, project, etc. Therefore, when a merchant CC is processed that relates to “materials and supplies”, method 300 associates those merchant CCs with the new transaction category “new building project”.

TABLE 3

| Merchant | Merchant | Transaction | Transaction |
|---|---|---|---|
| Name | CC | Category | Sub-Category |
| United Airlines | 11220 | Travel | United |
| McDonalds | 24577 | Meals & Entertainment | Eating Places/ |
| | | | Restaurants |
| Mobile | 36747 | Vehicle | Service Station |
| Coast Hotels | 56000 | Lodging | Coast Hotels |
| Southwest | 18383 | Travel | Southwest |
| Airlines | | | |
| Shell | 33831 | Vehicle | Service Station |
| Burger King | | Not Categorized | |
| Home Depot | 60121 | New Building | Construction |
| | | Project | Materials |
| Disneyland | 25789 | Meals & | Disneyland |
| | | Entertainment | |
| AAA | 89899 | Business Services | Auto Associations |

At step 320, a determination is made whether to move the sub-categories between transaction categories. In one configuration, as illustrated in FIG. 9, the user may interactively use the financial transaction category modification interface 900 to select which sub-categories to move. For example, as illustrated in FIG. 9, in window 904, selecting the plus sign (+) disposed adjacent a given transaction category allows the user to expand, view, and select available sub-category from each respective transaction category. For example, under the transaction category of “cash advances”, the user may use check boxes 906 to select those merchants having merchant CCs that match the sub-categories under the “cash advance” category. As illustrated in FIG. 9, for example, the sub-categories under the transaction category of “CASH ADVANCES” included “ELECTRONIC CASH WITHDRAWAL”, “FINANCIAL INST/AUTO CASH”, “FINANCIAL INST/MANUAL CASH”, and “NON-FIN INST/FC/MO/TC/ST CASH”. In one embodiment a “select all” check box may be employed to allow a user to select all of the sub-categories listed. Similarly, if the user selects the plus sign (+) associated with the “travel” transaction category, the user is allowed to select sub-categories matched with merchant CCs under the transaction category “travel”.

Once the sub-categories have been selected, as illustrated in FIG. 10B a user interface 1020 allows the user to move the sub-categories from one transaction category to another transaction category. The user employs a category selection drop down box 1012 to select the transaction category in which to move the sub-categories. If the user does not want to move sub-categories, then the method 300 proceeds to step 322.

Table 4, illustrates the result of moving the sub-category “auto associations” from the transaction category of “business services” to the transaction category of “vehicle”. Therefore, after moving the sub-category “business services” to “auto associations”, when a merchant CC is processed that stipulates the sub-category of “auto associations”, method 300 associates those merchant CCs with the transaction category “vehicle”.

TABLE 4

| | Merchant | Transaction | Transaction |
|---|---|---|---|
| Merchant Name | CC | Category | Sub-Category |
| United Airlines | 11220 | Travel | United |
| McDonalds | 24577 | Meals & | Eating Places/ |
| | | Entertainment | Restaurants |
| Mobile | 36747 | Vehicle | Service Station |
| Coast Hotels | 56000 | Lodging | Coast Hotels |
| Southwest Airlines | 18383 | Travel | Southwest |
| Shell | 33831 | Vehicle | Service Station |
| Burger King | | Not Categorized | |
| Home Depot | 60121 | New Building | Construction |
| | | Project | Materials |
| Disneyland | 25789 | Meals & | Disneyland |
| | | Entertainment | |
| AAA | 89899 | Vehicle | Auto Associations |

At step 322, a determination is made whether to add a transaction category. FIG. 10C illustrates a user interface 1030 that allows the user to add a new transaction category by entering the transaction category name in text boxes 1032. If the user does not want to add a new transaction category then the method 300 proceeds to step 324. At step 324, a determination is made whether or not to delete a transaction category. FIG. 10D illustrates a user interface 1040 that allows the user to delete a transaction category using drop down box 1042. If the user does not want to delete a transaction category then the method 300 proceeds to step 330. In one embodiment, all of the sub-categories associated with the transaction category to be deleted must be moved to another transaction category before the transaction category is deleted.

Table 5, illustrates the result of adding the transaction category “personal travel” to help categorize transactions that relate to a user's personal travel expenses versus business travel expenses. In this example, the sub-category “Disneyland” was also moved to the new transaction category. Therefore, after adding the transaction category “personal travel”, when a merchant CC is processed that stipulates the transaction category of “Disneyland”, method 300 associates those merchant CCs with the transaction category “personal travel”.

TABLE 5

| | Merchant | Transaction | Transaction |
|---|---|---|---|
| Merchant Name | CC | Category | Sub-Category |
| United Airlines | 11220 | Travel | United |
| McDonalds | 24577 | Meals & | Eating Places/ |
| | | Entertainment | Restaurants |
| Mobile | 36747 | Vehicle | Service Station |
| Coast Hotels | 56000 | Lodging | Coast Hotels |
| Southwest Airlines | 18383 | Travel | Southwest |
| Shell | 33831 | Vehicle | Service Station |
| Burger King | | Not Categorized | |
| Home Depot | 60121 | New Building | Construction |
| | | Project | Materials |
| Disneyland | 25789 | Personal Travel | Disneyland |
| AAA | 89899 | Vehicle | Auto Associations |

At step 330, a determination is made whether to restore the transaction categories stored for example, in database 110. FIG. 10E illustrates a user interface 1050 that allows the user to restore default transaction categories using check box 1052. If the user does not want to restore a transaction category, e.g., the user wants to save the modified transaction categories for future inquires, then the method 300 ends at step 340.

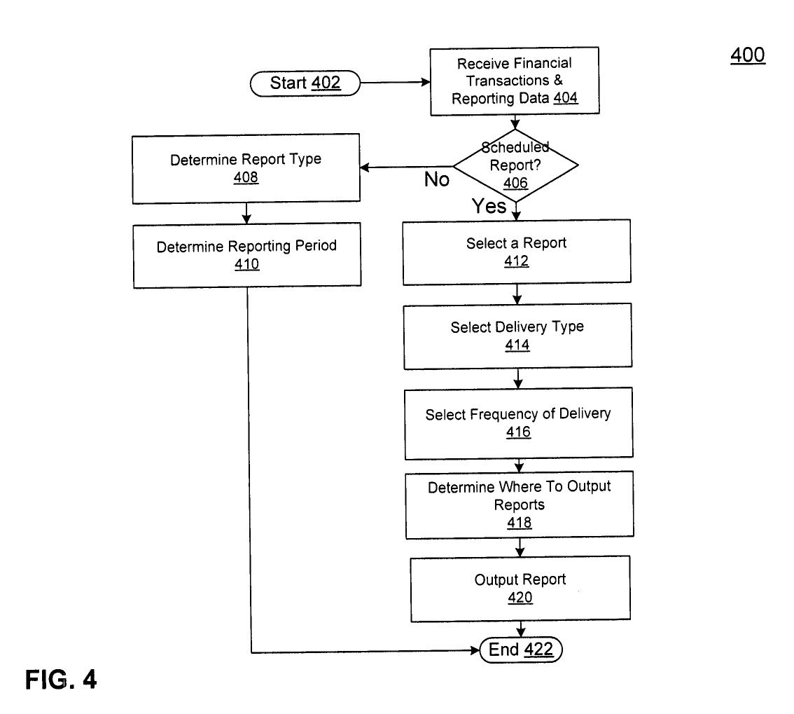

FIG. 4 is flow diagram illustrating a method 400 of reporting financial transactions. Method 400 starts at step 402, for example, when a user interacts with the financial transaction tracking and reporting system 200. For example, in one embodiment, after a user has logged on with a user name and password, the user may navigate via a user interface to perform a number of operations such create and manage an e-mail distribution list, generate one-time financial transaction reports, setup scheduled financial transaction reports, and the like.

While the reports described herein provide transaction data, such as payment amount, date, transaction ID, etc., typically supplied by the issuer, merchant, payment processing system, and the like, in one embodiment, it is contemplated that at least some of transaction data may provided by the user. For example, method 400 may provide for data entry by a user to allow users to additional information to the reports via a comments field or other information entry portal. This is advantageous as allowing a user to manually add a code, comment, indicia, symbols, and the like on reports provides the user with the ability to distinguish transactions with additional information. Such additional information, for example, may be used to allow the user to flag business transactions and personal transactions. In one embodiment, for reports that are provided in a searchable database format such as a spreadsheet, a user may sort the transactions by such additional information. The additional information may be stored for example, in database 110.

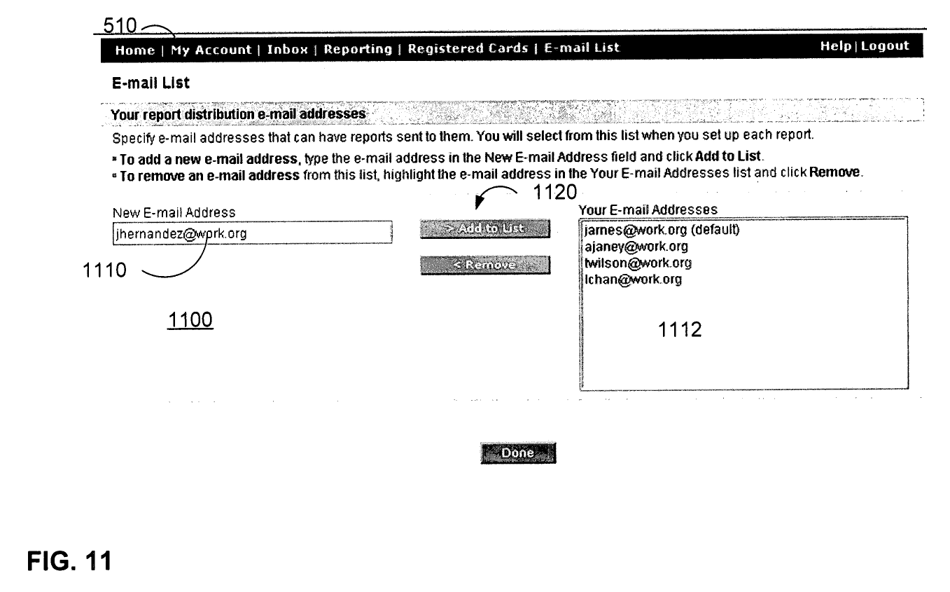

At step 404, the method 400 receives account information and financial data from for example database 110. In one embodiment, a user may use navigation bar 510 to navigate to an e-mail distribution list interface. For example, FIG. 11 is a simplified graphical display illustrating e-mail list management interface 1100. The e-mail list management interface 1100 provides the user with an e-mail address entry window 1110 and an e-mail distribution list window 1112. E-mail address entry window 1110 enables a user to enter a new e-mail address for addition to the e-mail distribution list window 1112. E-mail list management interface 1100 also provides e-mail addition and deletion buttons 1120 to enable the user to add e-mail address to, or remove e-mail address from e-mail distribution list window 1112.

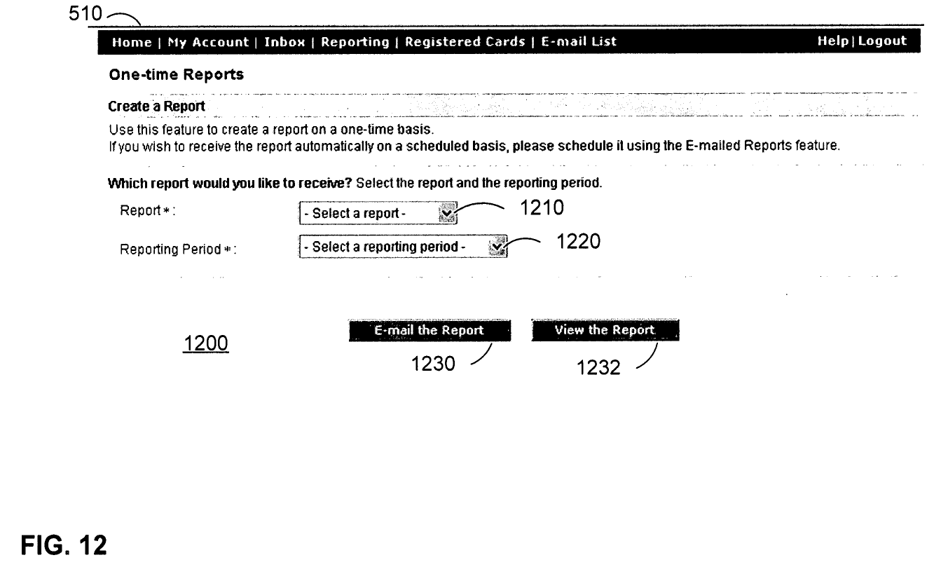

A determination is made whether a one-time report or scheduled report is selected at step 406. For example, at step 406 a user may use navigation bar 510 to navigate to a non-scheduled report interface as shown in FIG. 12, which illustrates a simplified graphical display of a non-scheduled report interface 1200. In one embodiment, the one-time financial reports allow a user to view the one-time report and/or e-mail the one-time report to a given e-mail address. Non-scheduled report interface 1200 provides a user with checkboxes and selection windows to select a one-time financial report for a given time period.

At step 406, if a one-time report is selected, then at step 408, a report type and a time period for the report is selected. In one embodiment, non-scheduled report interface 1200 includes a report selection dropdown box 1210 and a reporting period drop down box 1220. Report selection dropdown box 1210 is used to select a report type. Illustratively, the user may select from a variety of reports such as cardholder summary, cardholder detail, company summary, spending summary, spending detail, and the like, some of which are described below. At step 410, the method 400 queries the database 110, for example, to obtain financial transactions over a given time period. In one embodiment, reporting period drop down box 1220 allows a user to specify a particular time period for the report such as monthly, quarterly, annually, and the like. The user may e-mail or view the report by selecting e-mail report button 1230 to e-mail the report, or view button 1232 to view the report on browser 204, for example.

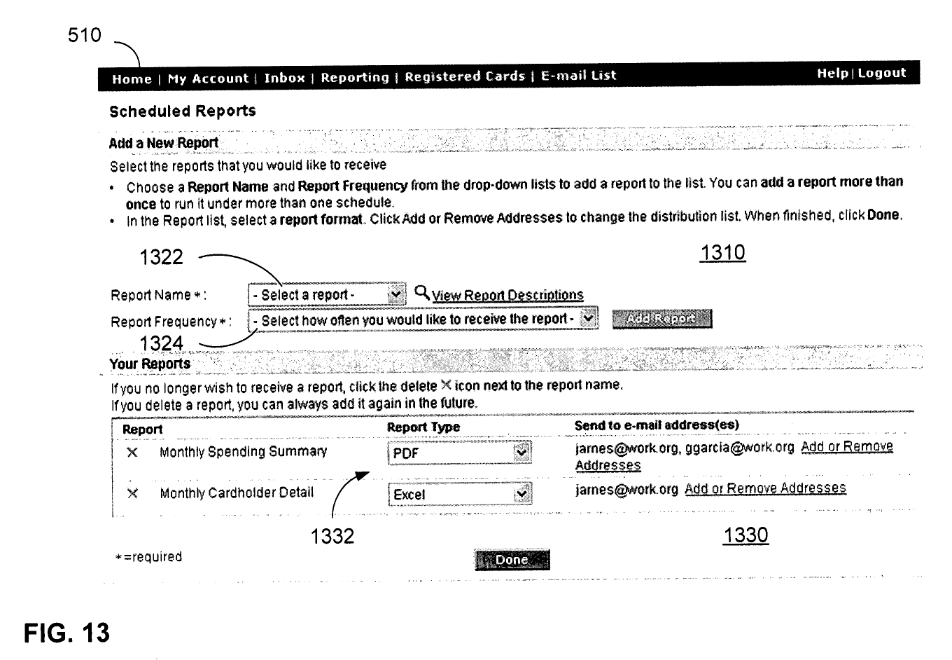

Alternatively, at step 406 if a scheduled report is selected, then at step 412 a report type to be scheduled is selected. For example, FIG. 13, shows is a simplified graphical display of a scheduled report interface 1300. Scheduled report interface 1300 includes a current scheduled report window 1330 which lists the currently scheduled reports, and an add report window 1310. Add report window 1310 allows a user to select a report type to schedule such as cardholder summary, cardholder detail, company summary, spending summary, spending detail, and the like, using a report selection dropdown box 1322. At step 414, the type of report format to deliver is chosen. Method 400 allows the user to select a variety of report formats that meet the needs of a give application. For example, as illustrated in FIG. 13, a user may use a report type dropdown box 1332 to select the data output type for each scheduled report such as PDF, spreadsheet, XML, comma separated value (CSV), tab delimited, HTML, text, and the like.

At step 416, the scheduled report frequency of delivery is selected. Method 400 allows the user to schedule report deliver for a variety of reporting periods. For example, as illustrated in FIG. 13, a user may select a reporting frequency from a reporting frequency dropdown box 1324. In one embodiment, the reporting frequency dropdown box 1324 allows the user to select reporting frequencies of monthly, quarterly, annually, and the like. In one embodiment, a determination is made of where and how to deliver the reports at step 418. For example, the method 400 may send the reports to all of the e-mails listed in the e-mail distribution list, for example as illustrated in FIG. 11. At step 420, at the prescribed time-periods reports are generated and delivered to users.

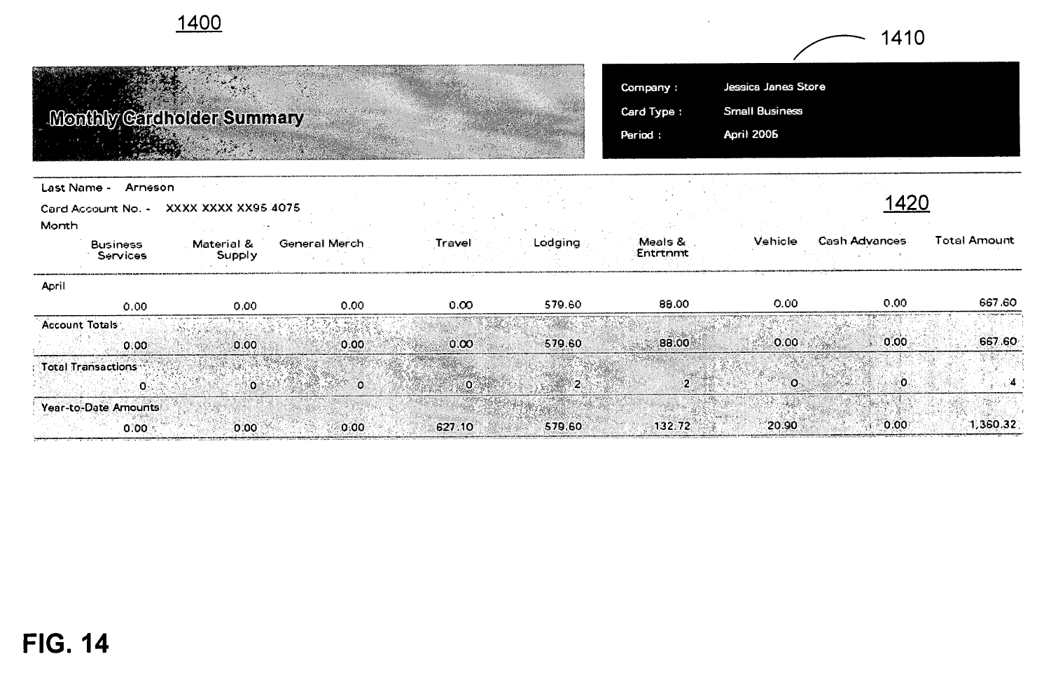

FIGS. 14-18 illustrate exemplary embodiments of reports generated by financial tracking and reporting system 200. For example, FIG. 14 is a simplified graphical display illustrating a monthly financial transaction summary 1400 for a user. The monthly financial transaction summary 1400 recaps spending by individual portable consumer device accounts per calendar month, quarter, year, and the like. Financial transactions are summarized and totaled for the time period. In this embodiment, monthly financial transaction summary 1400 includes a user account information section 1410 and transaction summary report section 1420. User account information section 1410 includes information pertaining to the user of the account such as user name, company name, card type, report period, etc. Transaction summary report section 1420 displays the financial transactions by transaction category such as a merchant category group (MCG), for a given time period. For example, as illustrated, the financial transactions may be grouped by transaction categories such as business services, material and supply, general merchandise, travel, lodging, meals and entertainment, vehicle, cash advance, etc.

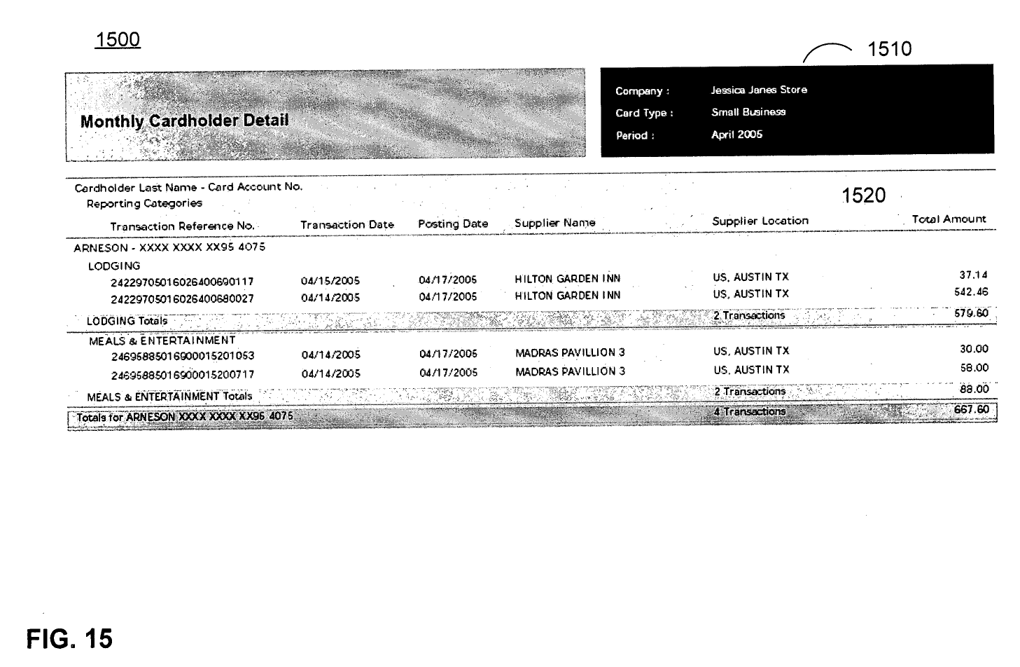

In one embodiment, FIG. 15 illustrates a simplified graphical display of a monthly financial transaction detail report 1500 for a user. Financial transaction detail report 1500 displays financial transactions by portable consumer device account for periods such as a monthly, quarterly, annually, etc. Financial transaction detail report 1500 recaps spending detail by individual accounts for the specified period with transactions grouped by transaction category. In this embodiment, financial transaction detail report 1500 includes a user account information section 1510 and transaction detail report section 1520. User account information section 1510 includes information pertaining to the user of the account such as user name, company name, card type, report period, etc. Transaction detail report section 1520 displays the financial transactions in more detail relative to the summary report. For example, transaction detail report section 1520 displays transaction reference number, transaction date, posting date, supplier name, the amount of the financial transaction, etc. for each individual financial transaction.

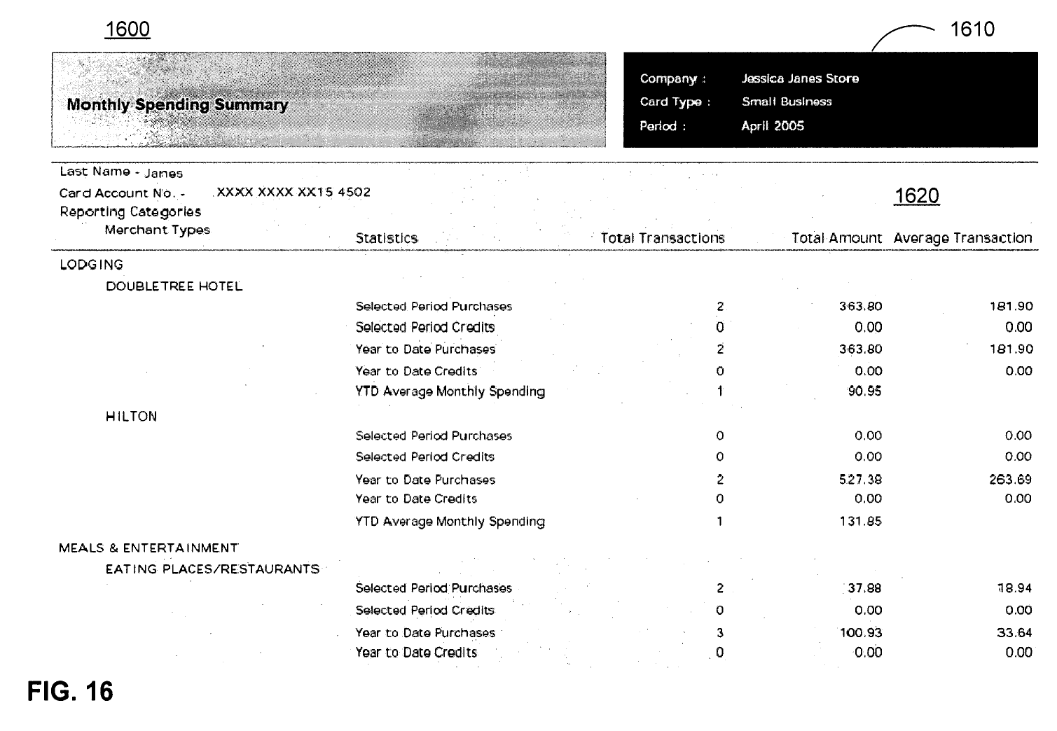

In one embodiment, FIG. 16 illustrates a simplified graphical display of a financial transaction spending summary report for a user. Financial transaction spending summary report 1600 displays financial transaction in summary form by portable consumer device account for periods such as a month, quarter, year, etc. Financial transaction spending summary report 1600 provides information about account transactions for the portable consumer device within transaction categories. For example, financial transaction spending summary report 1600 displays period purchases and credits, year-to-date purchases and credits and year-to-date average monthly spending at a sub-category level within each transaction category and provides transaction totals for each transaction category. In this embodiment, financial transaction spending summary report 1600 includes a user account information section 1610 and transaction summary report section 1620. User account information section 1610 includes information pertaining to the user of the account such as user name, company name, card type, report period, etc. Transaction summary report section 1620 displays the financial transactions in summary form. For example, transaction summary report section 1620 displays transactions by merchant transaction types, statistics, number of transactions, total monetary amount, average transaction amount, etc.

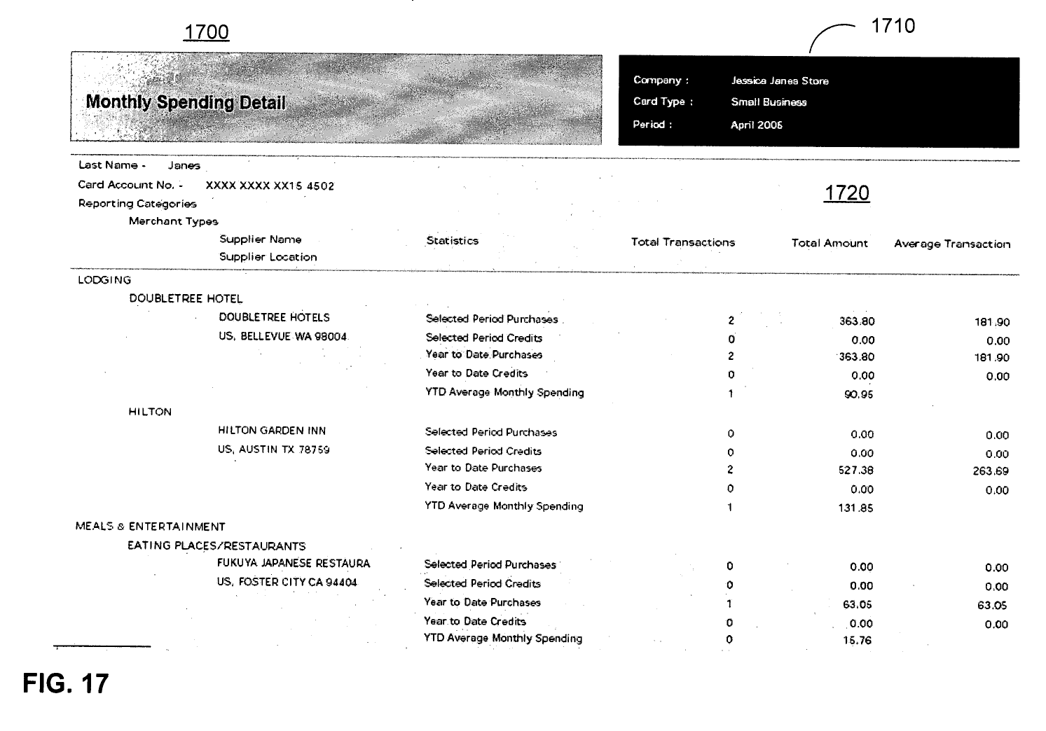

In another embodiment, FIG. 17 illustrates a simplified graphical display of a financial transaction spending detail report 1700 for a user. Financial transaction spending detail report 1700 displays financial transaction details by portable consumer device account for periods such as a month, quarter, year, etc. Financial transaction spending detail report 1700 provides detail information about account transactions for the portable consumer device type within transaction categories. For example, financial transaction spending detail report 1700 provides detail information about cardholder transactions for each merchant within their transaction category (e.g., lodging, meals and entertainment, etc.). In one embodiment, financial transaction spending detail report 1700 also displays period purchases and credits, year-to-date purchases and credits and year-to-date average monthly spending for each merchant and provides individual totals for each merchant. In this embodiment, financial transaction spending detail report 1700 includes a user account information section 1710 and transaction detail report section 1720. User account information section 1710 includes information pertaining to the user of the account such as user name, company name, card type, report period, etc. Transaction detail report section 1720 displays the financial transactions in detail form. For example, transaction summary report section 1720 displays transactions by merchant, merchant lpcation, statistics (e.g., year to date purchases), total transactions by transaction category, merchant name, total amount of each transaction, average transaction amount, etc.

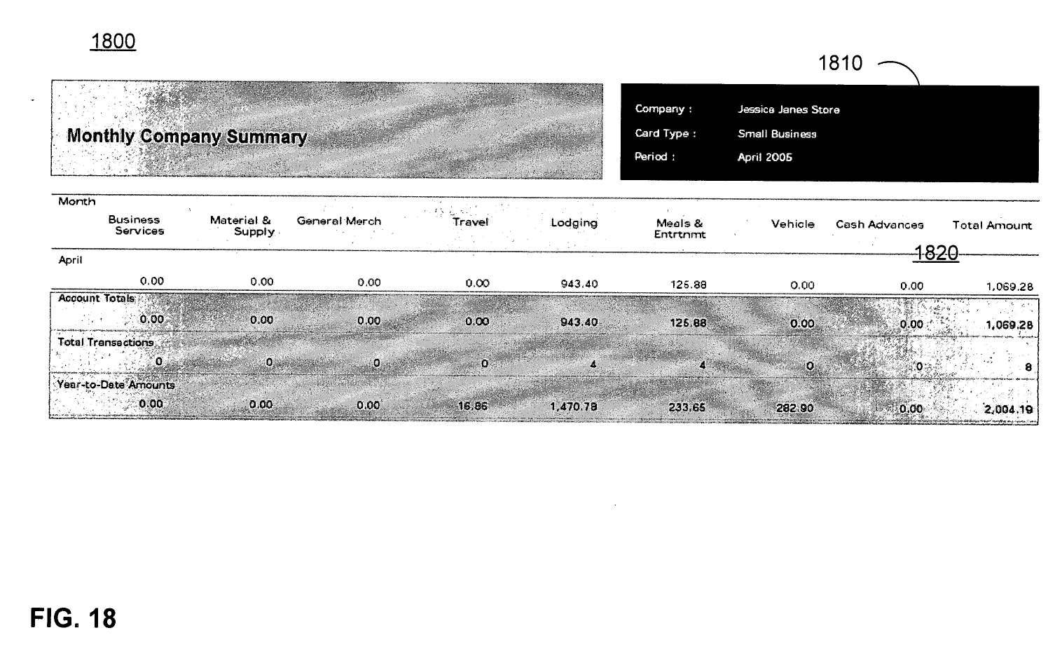

In one embodiment, FIG. 18 illustrates a simplified graphical display of a financial transaction summary report 1800 for an organization such as a company. Financial transaction summary report 1800 displays financial transaction summarized by portable consumer devices registered under the companies account for periods such as a month, quarter, year, etc. Financial transaction summary report 1800 is capable of providing summary information about financial transactions for portable consumer devices categorized within transaction categories and also recaps spending for credit and debit card accounts by an entire organization for a time period such as a monthly, quarterly, annually, etc. In one embodiment, financial transactions are summarized by month and totaled for the year by transaction categories. In this embodiment, financial transaction summary report 1800 includes a company account information section 1810 and transaction summary report section 1820. Company account information section 1810 includes information pertaining to the company account such as company name, consumer portable device type, report period, etc. Transaction summary report section 1820 displays the financial transactions in summary form with respect to transaction categories. For example, transaction summary report section 1820 displays transactions by transaction categories such as business service, materials and supplies, general merchandise, travel, lodging, meals and entertainment, vehicle, cash advance, etc. It is also noted that bill pay reminder systems and methods like those described in U.S. Application 60/724,497 filed Oct. 7, 2005 and U.S. application Ser. No. 11/329,929, filed Jan. 10, 2006 (Atty. Docket No. 16222U-023110US) may be used with embodiments of the invention. These applications are incorporated by reference in their entirety.

Any software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving at a server, purchase information relating to multiple purchase transactions made using one or more portable consumer devices;
assigning each purchase to a transaction category within a plurality of transaction categories, wherein each purchase is associated with a merchant classification code;
customizing the transaction categories; and
creating a report showing purchases made under the customized transaction categories.

2. The method of claim 1, wherein the customized transaction categories are customized by the server after a user selects the customized transaction categories from a list of pre-defined transaction categories.

3. The method of claim 1, wherein the customized transaction categories are specifically named by a user.

4. The method of claim 1, wherein the one or more portable consumer devices includes credit and debit devices, wherein the purchases include debit and credit devices transactions in the same report.

5. The method of claim 1, wherein if no merchant classification code is available then providing a default merchant classification code.

6. The method of claim 1, wherein assigning the purchases with a transaction category comprises moving purchases from a current transaction category to another transaction category specifically named or selected by a user.

7. The method of claim 1, wherein assigning the purchases with a transaction category comprises adding a new transaction category specifically named by a user.

8. A computer readable medium, computational apparatus, or server computer comprising computer code for performing the method of claims 1.

9. A method comprising:
receiving at a server, registrations for one or more portable consumer devices;
receiving purchase information for the one or more portable consumer devices;
associating a transaction category to at least some of the purchase information, wherein the transaction category is derived from the purchase information; and
generating a report including the purchase information for the one or more consumer devices,
wherein different users are able to register a specific number of portable consumer devices and generate reports only with respect to those registered portable consumer devices.

10. The method of claim 9, wherein the one or more portable consumer devices include credit and debit cards.

11. The method of claim 9, wherein the report includes both debit and credit device purchases on the same report.

12. A computer readable medium comprising code for performing the method of claim 9.

13. A financial tracking and reporting system, the system comprising:
a financial data input system capable of receiving financial transactions from portable consumer devices;
a data categorization system capable of categorizing at least some of the financial transactions into one of a plurality of transaction categories based on a merchant classification code, wherein the data categorization system is capable of customizing the transaction categories in response to a user input; and
a transaction reporting system capable of generating financial reports using at least some categorized financial transactions.

14. The system of claim 13, wherein the portable consumer devices comprise credit devices and debit devices.

15. The system of claim 13, wherein the data categorization system categories the financial transactions using a list of pre-defined transaction categories.

16. The system of claim 13, wherein the user input comprises customized categories specifically named by a user.

17. The system of claim 13, wherein the data categorization system categories the financial transactions by moving the financial transactions from one transaction category to another transaction category specifically named or selected by a user.

18. The system of claim 13, wherein the data categorization system categories the financial transactions by adding a user-defined transaction category.

19. The system of claim 13, wherein the data categorization system generates reports based on transaction categories specifically named or selected by a user.

20. The system of claim 13, wherein the data categorization system generates reports based on one or more time periods specifically named or selected by a user.

21. The system of claim 13, further comprising a portable consumer device registration system capable of registering credit and debit cards specifically named by a user.
